(19) United States
(12) Patent Application Publication
(10) Pub. No.: US 2014/0141642 A1
(43) Pub. Date: May 22, 2014

(54) ELECTRONIC CARD CONNECTOR AND ELECTRONIC DEVICE USING THE SAME

(71) Applicants: HON HAI PRECISION INDUSTRY CO., LTD., New Taipei (TW); Fu Tai Hua Industry (Shenzhen) Co., Ltd., Shenzhen (CN)

(72) Inventor: CHUN-YOU LIAO, Shenzhen (CN)

(73) Assignees: HON HAI PRECISION INDUSTRY CO., LTD., New Taipei (TW); Fu Tai Hua Industry (Shenzhen) Co., Ltd., Shenzhen (CN)

(21) Appl. No.: 14/065,439

(22) Filed: Oct. 29, 2013

(30) Foreign Application Priority Data
Nov. 19, 2012 (CN) 2012104674803

(51) Int. Cl. H01R 13/639

(52) U.S. Cl. CPC H01R 13/639
USPC 439/372

(57) ABSTRACT

An electronic device includes an electronic card connector. The electronic card connector includes a tray assembly configured to receive an electronic card, and a base configured to receive the tray assembly. The tray assembly includes a hook mechanism, and the base includes a hook engaging mechanism. The tray assembly is locked in the base by an engagement of the hook mechanism and the hook engaging mechanism. The base also includes an elastic member. The elastic member is configured to eject the tray assembly out of the base when the hook mechanism is disengaged from the hook engaging mechanism.

### BACKGROUND

1. Technical Field

Embodiments of the present disclosure relate to electronic card connectors, and particularly to an electronic card connector having a tray assembly and an electronic device using the electronic card connector.

2. Description of Related Art

Some electronic devices have electronic cards, such as a Subscriber Identity Module (SIM) card or a flash memory card, installed in a sidewall of the electronic device. However, when the electronic device requires a dedicated tool to eject the electronic card out of the sidewall, it is inconvenient for a user to carry and use the dedicated tool.

### BRIEF DESCRIPTION OF THE DRAWINGS

All the views are schematic.

FIG. 1 is an isometric view of an electronic device using an electronic card connector according to an exemplary embodiment of the present disclosure.

FIG. 2 is a partial, cutaway view of the electronic device of FIG. 1, showing the electronic card connector installed in the electronic device.

FIG. 3 is an exploded, isometric view of the electronic card connector shown in FIG. 2.

FIG. 4 is similar to FIG. 3, but viewed from another aspect.

FIG. 5 is a partial view of the electronic device of FIG. 1, showing a tray assembly of the electronic card connector being inserted into a base of the electronic card connector.

FIG. 6 is a partial view of the electronic device of FIG. 1, showing the tray assembly of the electronic card connector disengaged from the electronic device.

### DETAILED DESCRIPTION

The disclosure, including the accompanying drawings in which like reference numerals indicate similar elements, is illustrated by way of example and not by way of limitation. It should be noted that references to “an” or “one” embodiment in this disclosure are not necessarily to the same embodiment, and such references can mean “at least one.”

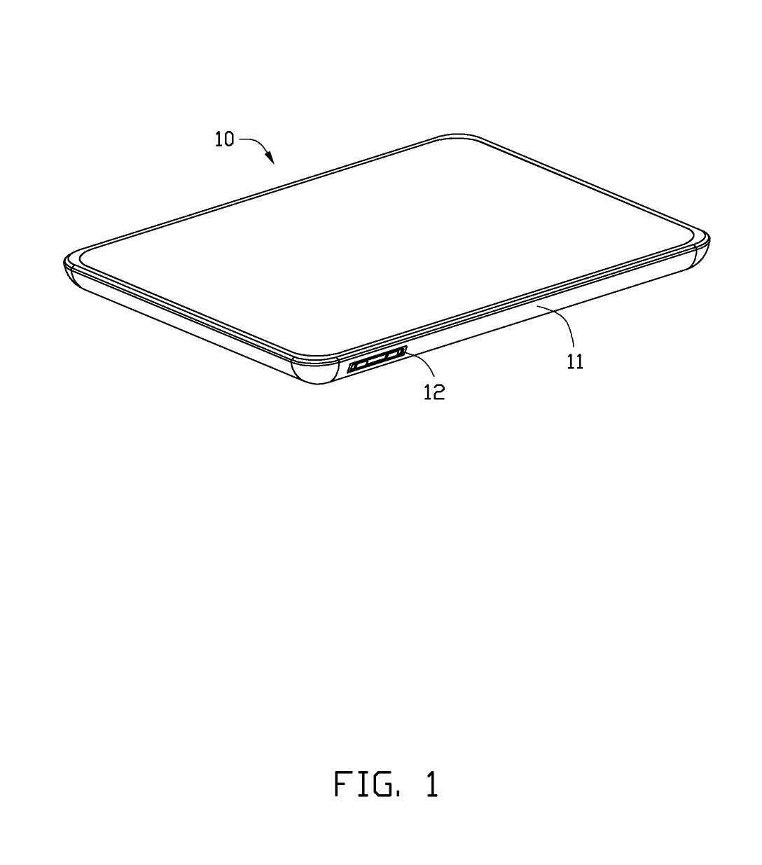

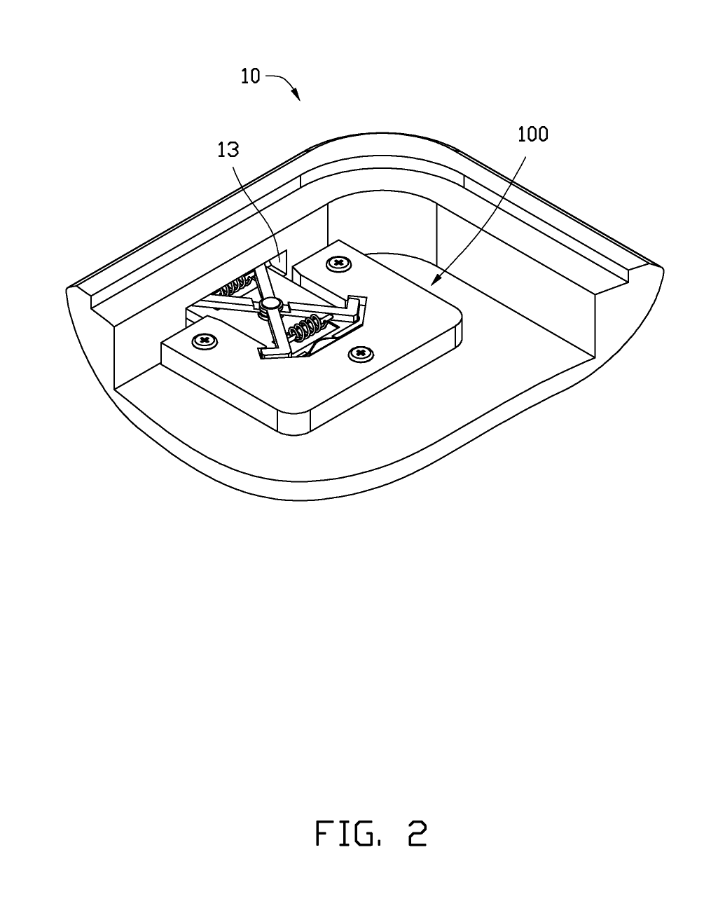

Referring to FIGS. 1-2, an electronic device 10 includes an electronic card connector 100. A recessed receiving portion 12 is defined in a sidewall 11 of the electronic device 10, and a slot 13 is defined in a bottom of the recessed receiving portion 12. The electronic card connector 100 is installed adjacent to a corner of the electronic device 10.

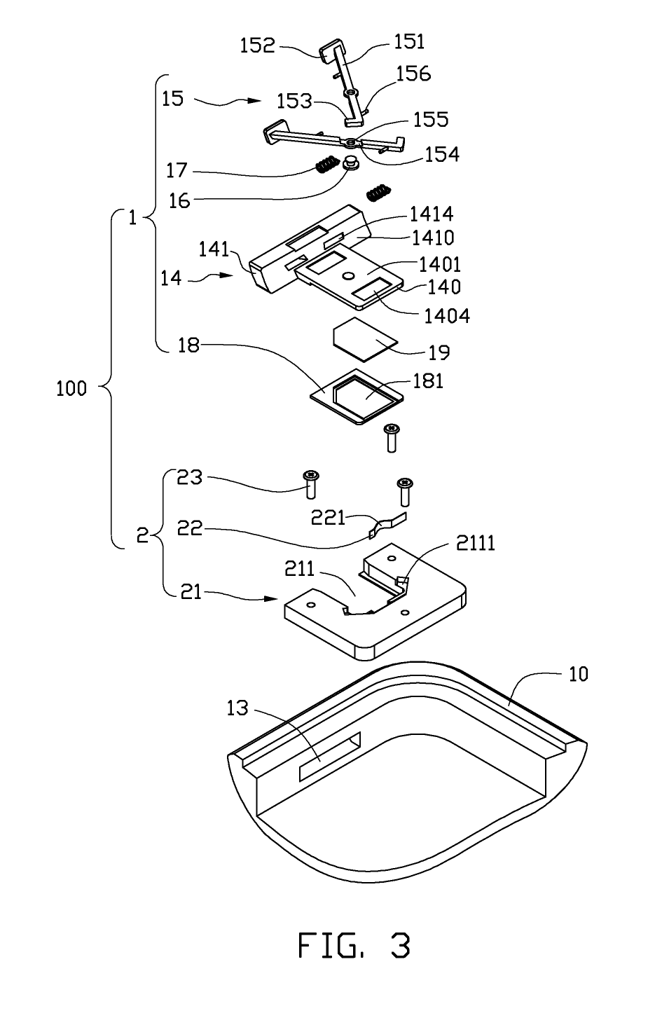

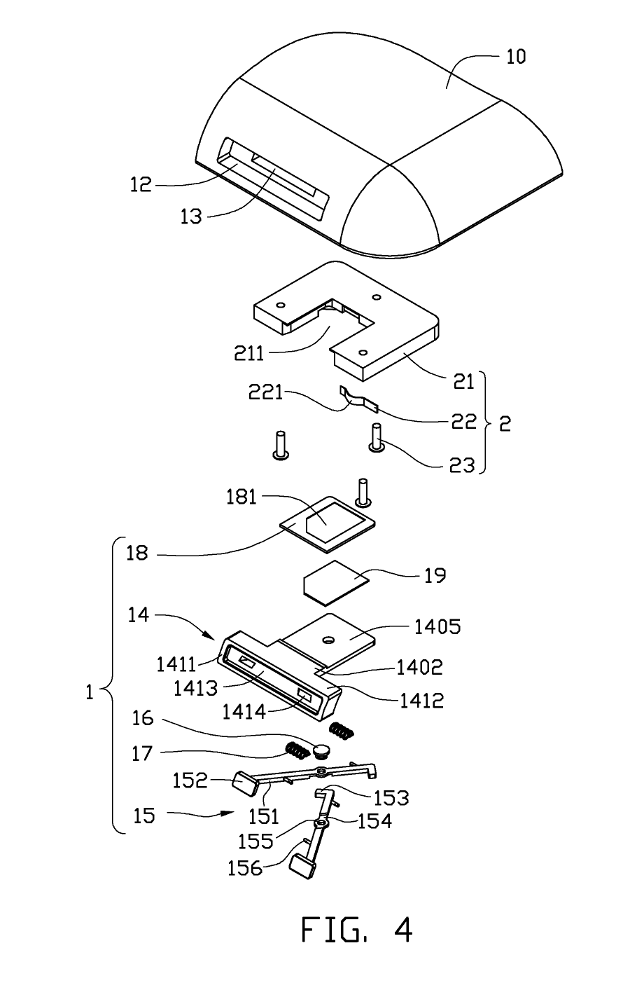

Referring to FIGS. 3-4, the electronic card connector 100 includes a tray assembly 1 and a base 2. The tray assembly 1 includes a sliding tray 14, a pair of locking rods 15, a pivot 16, two elastic components 17, and a support member 18. The sliding tray 14 includes a flat portion 140 and a baffle portion 141. The flat portion 140 is substantially rectangular and includes an upper surface 1401 and a lower surface 1402. A pivot through hole 1403 is defined in the flat portion 140. Two recesses 1404 are defined in the upper surface 1401 adjacent to opposite ends of the flat portion 140, respectively. An electronic card-receiving recessed portion 1405 is defined in the lower surface 1402.

The baffle portion 141 includes an inner surface 1410, an outer surface 1411, and a bottom surface 1412. A sunk portion 1413 is defined in the outer surface 1411, and two strip through holes 1414 are defined in a bottom of the sunk portion 1413. The two strip through holes 1414 are on a same level and extend along a direction substantially parallel to the bottom surface 1412. The flat portion 140 is connected to the inner surface 1410 of the baffle portion 141 and is located adjacent to the two strip through holes 1414, and the lower surface 1402 is coplanar with the bottom surface 1412.

Each locking rod 15 includes a body 151, a head 152 at one end of the body 151, and a hook 153 at an opposite end of the body 151. The head 152 is received in the sunk portion 1413. The head 152 is a substantially rectangular tab and is angled with respect to the body 151. The hook 153 is angled with respect to the body 151. The body 151 defines an oblique groove 154. A through hole 155 is defined in the bottom of the oblique groove 154. A depth of the oblique groove 154 is substantially half the size of a thickness of the locking rod 15. Two fixing pins 156 protrude from opposite sides of the body 151. One of the two fixing pins 156 is adjacent to the hook 153, and the other fixing pin 156 is adjacent to the head 152. The fixing pin 156 adjacent to the head 152 and the head 152 extend away from a same side of the body 151. The fixing pin 156 adjacent to the hook 153 and the hook 153 extend away from opposite sides of the body 151.

The base 2 includes a fixing body 21, an elastic member 22, and a number of fastening components 23. The fixing body 21 is fixed to a bottom of the electronic device 10 by the fastening components 23. The fixing body 21 defines a substantially rectangular receiving cavity 211 that receives the tray assembly 1. An open end of the receiving cavity 211 faces the slot 13. Two hook-receiving cavities 2111 are defined in a top surface of the fixing body 21. The hook-receiving cavities 2111 communicate with the receiving cavity 211. In the illustrated embodiment, the two hook-receiving cavities 2111 are defined in opposite bottom corners of the receiving cavity 211, and each of the two hook-receiving cavities 2111 is similarly angled with respect to a corresponding sidewall of the receiving cavity 211. The elastic member 22 is arranged at a bottom surface of the receiving cavity 211 and includes an arcuate portion 221 protruding toward the open end of the cavity 211.

In assembly of the tray assembly 1, the two locking rods 15 are inserted through the two strip through holes 1414, intersected and overlapped with each other by the two oblique grooves 154. When the two locking rods 15 are overlapped, the overlapped portions are on the same level as the non-overlapped portions and the two through holes 155 of the locking rods 15 overlap each other. The hooks 153 of the two locking rods 15 are received in a corresponding hook-receiving cavity 2111, and the two heads 152 are received in the sunk portion 1413. The two heads 152 are flush with the outer surface 1411 and spaced a distance from the bottom of the sunk portion 1413. The pivot 16 is received in the two overlapped through holes 155 and the pivot through hole 1403, thereby rotatably connecting the two locking rods 15 to the sliding tray 14. One of the two elastic components 17 is connected between the two fixing pins 156 adjacent to the hooks 153, while the other elastic component 17 is connected between the two fixing pins 156 adjacent to the head 152. The two elastic components 17 are partially received in a corresponding recess 1404. The two elastic components 17 apply a pushing force to the two locking rods 15. The support member 18 includes an open bottom slot 181. The support member 18 covers the electronic card-receiving recessed portion 1405, such that the open bottom slot 181 faces the card-receiving recessed portion 1405. The electronic card 19 is received in the open bottom slot 181. In the illustrated embodiment, the two elastic components 17 are springs.

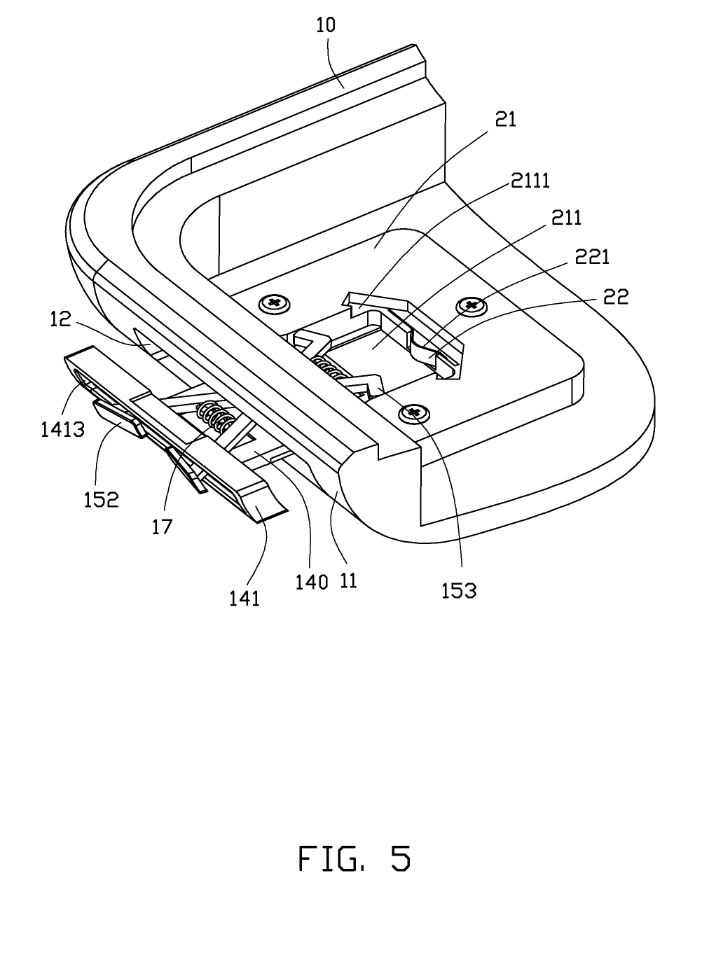

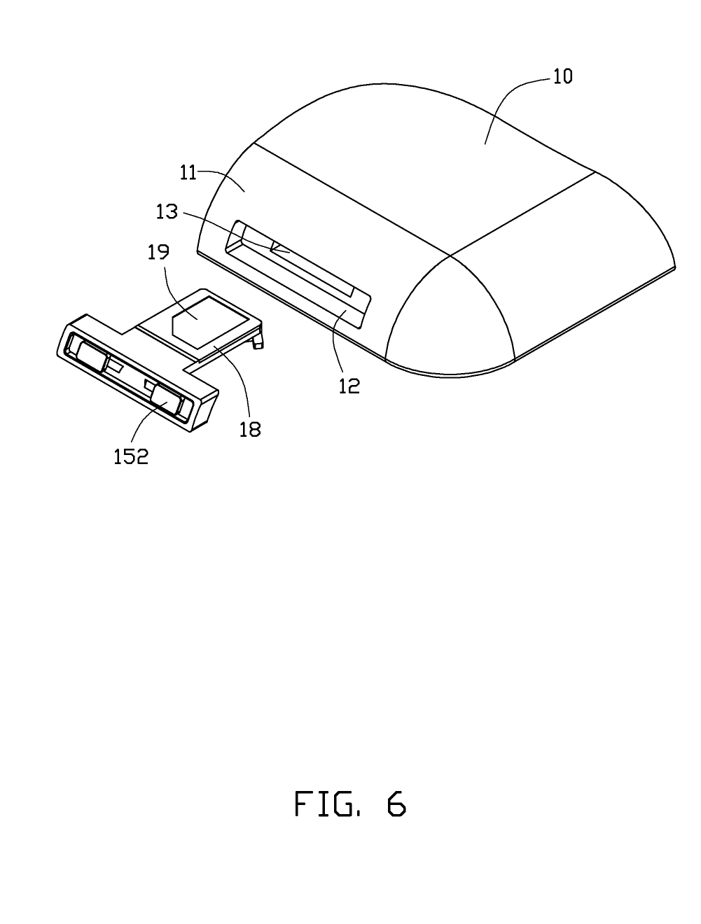

Referring to FIGS. 5-6, to insert the tray assembly 1 into the electronic device 10, the two heads 152 are pushed toward each other, thereby causing the two locking rods 15 to rotate about the pivot 16. The two hooks 153 move toward each other to be received in the receiving cavity 211. The tray assembly 1 is then pushed until the flat portion 140 is completely received in the receiving cavity 211. The two heads 152 are released, and the elastic components 17 resiliently push the two hooks 153 to be received in the two hook-receiving cavities 2111, thereby locking the tray assembly 1 in the base 2. The end of the flat portion 140 away from the baffle portion 141 resiliently abuts the arcuate portion 221 of the elastic member 22.

To release the tray assembly 1 from the base 2, the two heads 152 are pushed toward each other, thereby causing the two locking rods 15 to rotate about the pivot 16. The two hooks 153 then move toward each other to release from the two hook-receiving cavities 2111. The tray assembly 1 is then ejected partially out of the electronic device 10 by the compressed elastic member 22 and can be pulled out of the electronic device 10.

Although certain inventive embodiments have been specifically described, the present disclosure is not to be construed as being limited thereto. Various changes or modifications may be made to the present embodiments without departing from the scope and spirit of the present disclosure.

What is claimed is:

1. An electronic card connector comprising:
a base comprising:
a receiving cavity with an open end; and
two hook-receiving cavities defined in a top surface of the base and communicating with the receiving cavity, the two hook-receiving cavities being located at opposite sides of the receiving cavity;
an tray assembly comprising:
a sliding tray configured to carry an electronic card;
two locking rods rotatably connected to an upper surface of the sliding tray, the two locking rods intersecting and rotatably connected with each other; two hooks each being defined at an end of one of the two locking rods, the two hooks being received in the two hook-receiving cavities to lock the sliding tray in the receiving cavity; and
two elastic components, one of the two elastic components being connected between the two locking rods and adjacent the two hooks, the other elastic component being connected between the two locking rods and adjacent to ends of the two locking rods opposite to the hooks, and the two elastic components applying a pushing force to the two locking rods.

2. The electronic card connector of claim 1, wherein the base further comprises an elastic member arranged at a bottom surface of the receiving cavity, the elastic member comprises an arcuate portion protruding toward the open end of the receiving cavity; the arcuate portion resiliently abuts an end of the sliding tray when the tray assembly is locked in the receiving cavity.

3. The electronic card connector of claim 2, wherein the receiving cavity is substantially rectangular, the two hook-receiving cavities are defined in opposite bottom corners of the receiving cavity.

4. The electronic card connector of claim 3, wherein the sliding tray comprises a substantially rectangular flat portion and a support member, an electronic card-receiving recessed portion is defined in a lower surface of the flat portion, and the support member covers the electronic card-receiving recessed portion; an open bottom slot is defined in the support member, and the electronic card is received in the open bottom slot.

5. The electronic card connector of claim 4, wherein the tray assembly further comprises a pivot, the pivot is fixed to the upper surface of the flat portion and passes through the two overlapped locking rods, and the two locking rods are rotatable about the pivot.

6. The electronic card connector of claim 5, wherein an oblique groove is defined in each of the two locking rods, the depth of the oblique groove is substantially half of the thickness of the locking rod; a pivot through hole is defined at the bottom of the oblique groove; the two locking rods are intersected and overlapped by the oblique grooves, and the pivot passes through the two overlapped pivot through holes.

7. The electronic card connector of claim 6, wherein each of the two locking rods further comprises a head at an end away from the hook, and the head is substantially rectangular tab.

8. The electronic card connector of claim 7, wherein the two elastic components are springs.

9. An electronic device comprising:
a sidewall, a recessed receiving portion along the sidewall being defined in the sidewall, a slot being defined in a bottom of the recessed receiving portion;
an electronic card connector comprising:
a base fixed on a bottom of the electronic device comprising:
a receiving cavity with an open end, the open end of the receiving cavity being opposite to the slot;
two hook-receiving cavities defined in a top surface of the base and communicating with the receiving cavity, the two hook-receiving cavities being located at opposite sides of the receiving cavity;
an tray assembly comprising:
a sliding tray configured to carry an electronic card;
two locking rods rotatably connected to a upper surface of the sliding tray, the two locking rods intersecting and rotatably connected with each other; two hooks each being defined at an end of one of the two locking rods, the two hooks being received in the two hook-receiving cavities to lock the sliding tray in the receiving cavity;
two elastic components, one of the two elastic component being connected between the two locking rods and adjacent the two hooks, the other elastic component being connected between the two locking rods and adjacent to ends of two locking rods opposite to the hooks, and the two elastic components applying a pushing force to the two locking rods.

10. The electronic device of claim 9, wherein the base further comprises an elastic member arranged at a bottom surface of the receiving cavity, the elastic member comprises an arcuate portion protruding toward the open end of the receiving cavity; the arcuate portion resiliently abuts an end of the flat portion away from the baffle portion when the tray assembly is locked in the receiving cavity.

11. The electronic device of claim 10, wherein the receiving cavity is substantially rectangular, the two hook-receiving cavities are defined in opposite bottom corners of the receiving cavity.

12. The electronic device of claim 11, wherein the sliding tray comprises:
a substantially rectangular flat portion, an electronic card-receiving recessed portion is defined in a lower surface of the flat portion;
a baffle portion configured to be received in the recessed receiving portion comprising an inner surface, an outer surface and a bottom surface; a sunk portion is defined in the outer surface, two strip through holes are defined in a bottom of the sunk portion and extend in a direction substantially parallel to the bottom surface; the flat portion is connected to the inner surface of the flat portion and located adjacent the two strip through holes with the lower surface coplanar with the bottom surface of the flat portion; and
a support member covers the electronic card-receiving recessed portion; an open bottom slot is defined in the support member, and the electronic card is received in the open bottom slot.

13. The electronic device of claim 12, wherein the tray assembly further comprises a pivot, the pivot is fixed to the upper surface of the flat portion and passes through the two overlapped locking rods, and the two locking rods are rotatable about the pivot.

14. The electronic device of claim 13, wherein a oblique groove is defined in each of the two locking rods, the depth of the oblique groove is substantially half of the thickness of the locking rod; a pivot through hole is defined at the bottom of the oblique groove; the two locking rods are intersected and overlapped by the oblique grooves, and the pivot passes through the two overlapped pivot through holes.

15. The electronic device of claim 14, wherein each of the two locking rods further comprises a head at an end away from the hook, the head is substantially rectangular tab, two heads of the two locking rods are received in the sunk portion, flush with the outer surface of the baffle portion, and spaced a distance from the bottom of the sunk portion.

16. The electronic device of claim 15, wherein the two elastic components are springs.
